(19) United States
(12) Patent Application Publication
(10) Pub. No.: US 2004/0216381 A1
(43) Pub. Date: Nov. 4, 2004

(54) Casement window operating assembly

(76) Inventor: Alain Clavet, Mirabel (CA)

Correspondence Address: George A. Seaby, Seaby & ASSOCIATES, 603-880 Wellington Street, Ottawa, ON, K1R 6K7, CA

(21) Appl. No.: 10/833,030

(22) Filed: Apr. 28, 2004

(30) Foreign Application Priority Data
May 1, 2003 (CA) 2,427,437

(51) Int. Cl. E05F 11/00

(52) U.S. Cl. 49/342

(57) ABSTRACT

An operating mechanism of a casement window includes a handle for rotating a worm shaft, which in turn rotates an inner gear, an annular gear and a crank arm to open a window. The crank arm is mounted on spaced apart pins on a flange or extension of the outer gear, so that the arm can be reversed on the pins to change the direction of window opening.

### BACKGROUND OF THE INVENTION

1. Field of the Invention

This invention relates to a window operating mechanism for opening and closing a casement window.

2. Discussion of the Prior Art

Casement windows have been in existence for a great many years. In the last forty or fifty years, operating or activating mechanisms have become standard equipment in casement window assemblies. Casement windows commonly open in one or two directions, depending upon whether the hinges are mounted on the left or the right hand side of the window. Typical operators for such windows are described in Canadian Patent No. 1,301,202, issued to D. A. Nolte et al on May 19, 1992; and in U.S. Pat. No. 3,044,311, issued to G. W. Gagnon on Jul. 17, 1962.

A problem inherent to existing window operating mechanisms is reversibility, i.e. the ability to adapt the mechanism to windows opening in the opposite directions. In existing devices, it is necessary to disassemble and then reassemble a substantial portion of the devices in order to be able to use the devices with windows opening in opposite directions.

### GENERAL DESCRIPTION OF THE INVENTION

An object of the present invention is to provide a solution to the above-identified problem in the form of a relatively simple window operating mechanism which can be quickly and easily modified for use on windows opening in opposite directions.

Accordingly, the invention relates to an operating mechanism for a casement window comprising:

(a) a hollow, closed housing for mounting on a casement window frame, said housing including:

(i) an opening in one side thereof;

(b) a worm shaft rotatable in said housing for manual actuation of the mechanism;

(c) an inner gear in said housing for rotation by said worm shaft;

(d) an annular outer gear in said housing for rotation by said inner gear, said outer gear including

(i) a flange extending out of said opening in the housing;

(e) spaced apart pins on said flange; and

(f) a crank arm releasably mounted on said pins for extending in one of two opposed directions,

whereby the operating mechanism can be readily adapted to windows opening in opposite directions.

### BRIEF DESCRIPTION OF THE DRAWINGS

The invention is described below in greater detail with reference to the accompanying drawings, which illustrate a preferred embodiment of the invention, and wherein:

FIG. 1 is an isometric view of a window operating mechanism in accordance with the invention as seen from above and an outer end;

FIG. 2 is an isometric view of the mechanism of FIG. 1 with parts removed;

FIGS. 3 to 5 are isometric views of a cover used on the mechanism of FIGS. 1 and 2 as seen from above (FIGS. 3 and 4) and below (FIG. 5);

FIG. 6 is a top view of the mechanism of FIGS. 1 and 2;

FIG. 7 is a cross section taken generally along line 7-7 of FIG. 6;

FIG. 8 is an inner end view of the mechanism of FIGS. 1 and 2;

FIG. 9 is a cross section taken generally along line 9-9 of FIG. 8;

FIG. 10 is an exploded, isometric view of interior elements of the mechanism of FIGS. 1 and 2; and

FIG. 11 is a cross section taken generally along line 11-11 of FIG. 6.

### DESCRIPTION OF THE PREFERRED EMBODIMENT

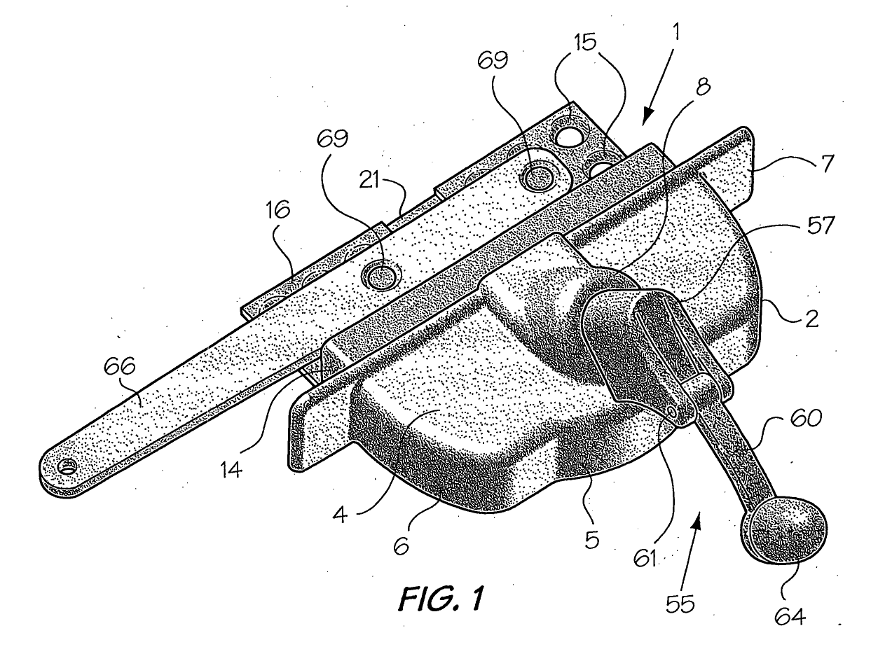

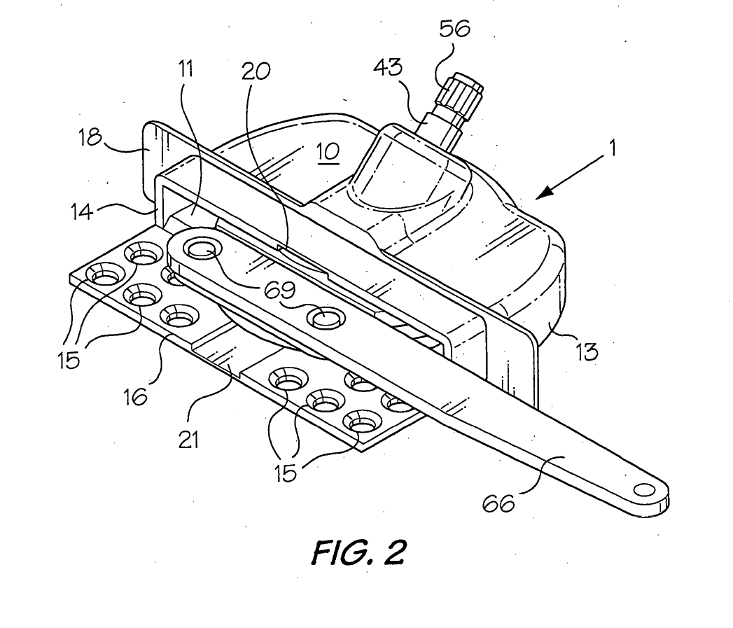

With reference to FIGS. 1 and 2 of the drawings, a window operating mechanism in accordance with the present invention includes a hollow, one-piece housing indicated generally at 1, which is covered by a cover 2.

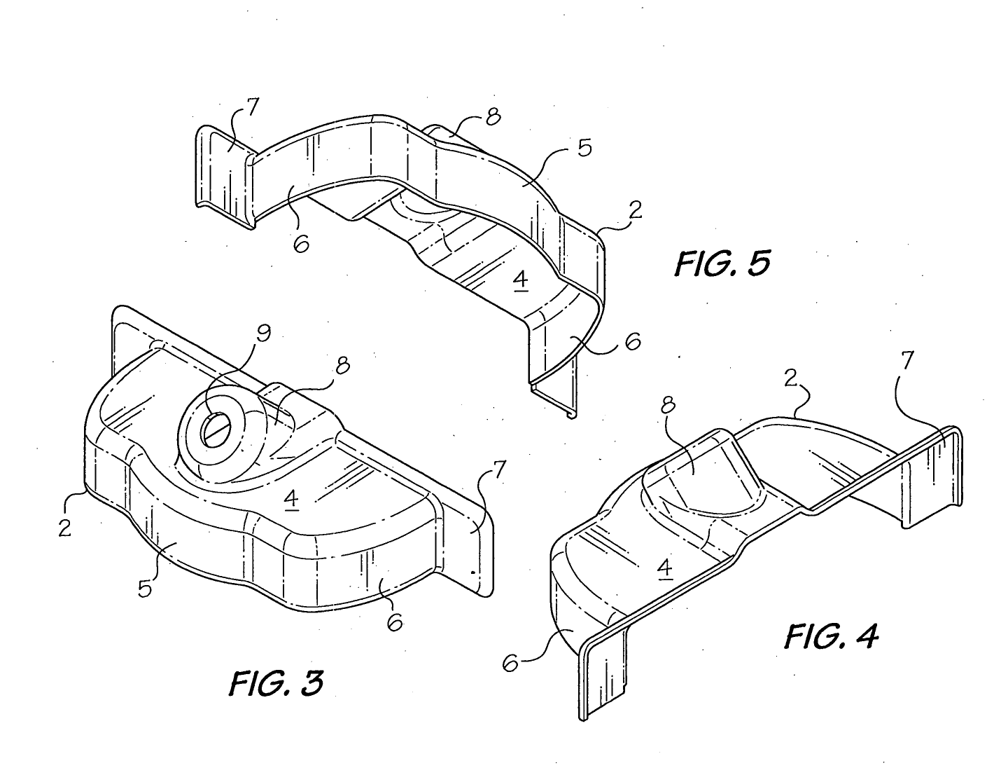

The one-piece hollow cover 2 (FIGS. 3 to 5) is defined by a top wall 4, an outer end wall 5, side walls 6 and a flange 7 extending upwardly from the inner end of the top wall 4 and outwardly from the side walls 6. A sleeve 8 extends upwardly from the top wall 4, and a hole 9 (FIG. 3) is provided in the otherwise closed top end of the sleeve.

The housing 1 (FIG. 2, where the cover 2 is omitted) includes a top wall 10, a bottom wall 11, an outer end wall 12 and side walls 13 extending between the top and bottom walls 10 and 11; respectively. The inner end 14 of the housing 1 is open for receiving various elements of the mechanism as described below. The bottom wall 11 extends outwardly a substantial distance beyond the open inner end 14 of the housing 1. A plurality of holes 15 are provided in the outer end 16 of the bottom wall 11 for receiving screws (not shown) for securely mounting the housing 1 on the ledge of a window in the conventional manner. Because a large number of window frames are made of plastic, it is sometimes necessary to use many screws to ensure a secure mounting of the operating mechanism. When mounting the mechanism on a window frame, the outer end 16 of the bottom wall 11 and the inner free ends of the top and side walls of the housing 1 are housed in a socket (not shown) in the window frame. A flange 18 near the inner end of the housing 1 limits movement of the housing into the socket. Actually, the flange 18 bears against a vertical surface of the window frame around the socket to stabilize the mechanism, i.e. reduce or eliminate torque on the screws holding the housing 1 in position during operation of the mechanism.

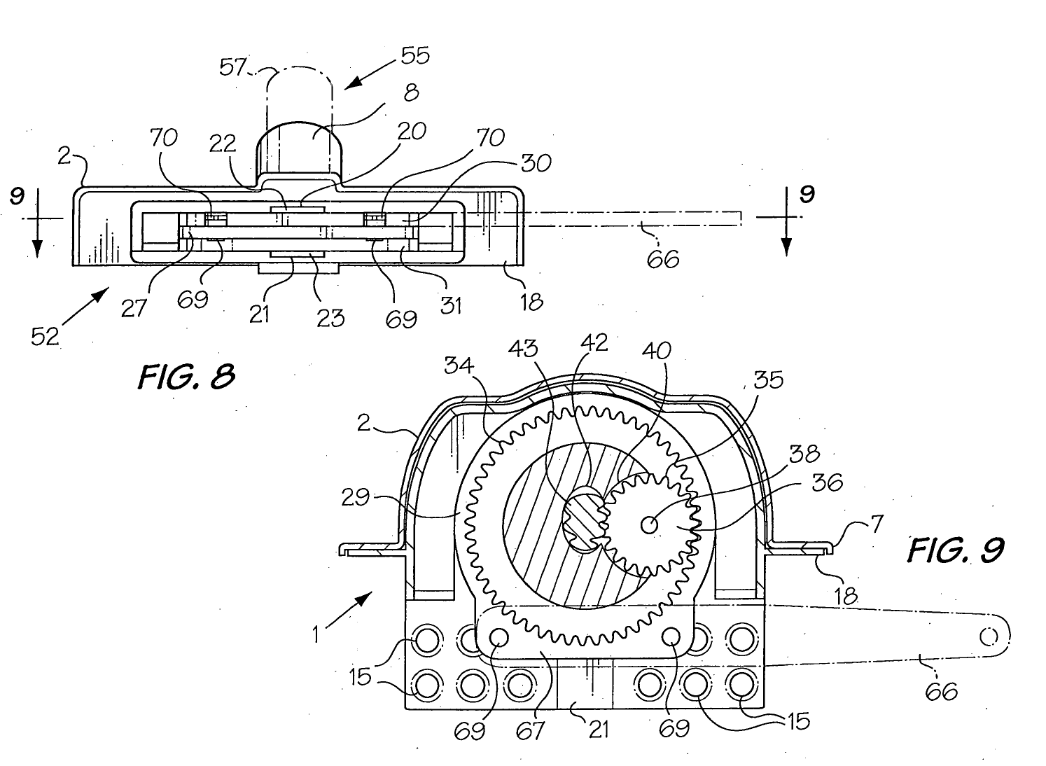

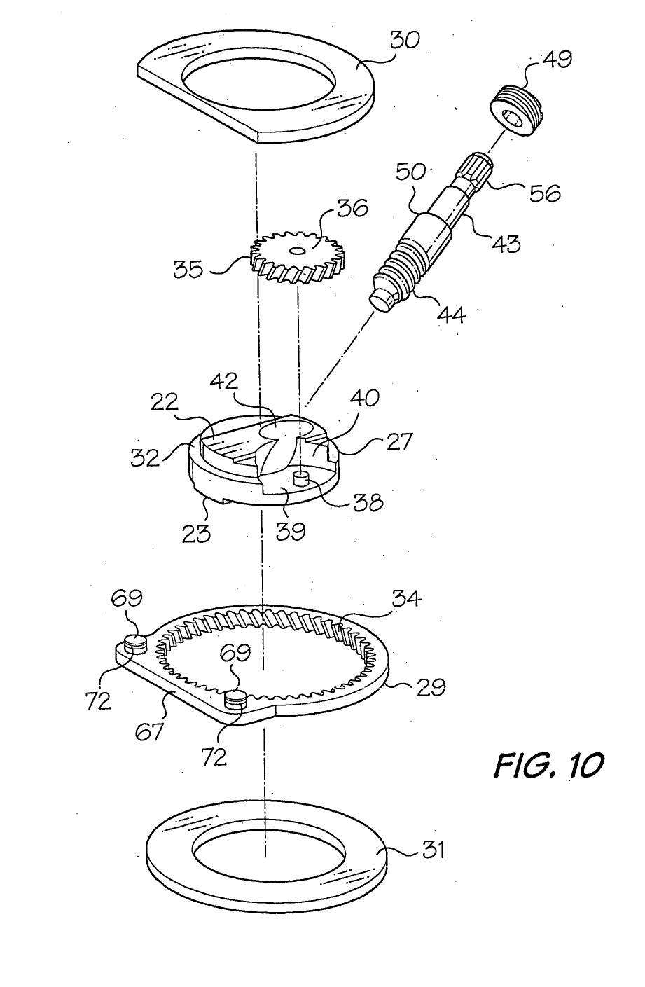

Rectangular notches 20 and 21 are provided in the centers of the interiors of the top and bottom walls 10 and 11, respectively of the housing for slidably receiving rectangular projections 22 and 23 on the top and bottom ends, respectively of a core body 27 of the mechanism. When the core body 27 is mounted in the housing 1, mating of the projections 22 and 23 with the notches 20 and 21 prevents rotation of the core body in the housing. As best shown in FIGS. 8 to 10, the core body 27 is generally-cylindrical for rotatably supporting an annular outer gear or gear ring 29 which is sandwiched between annular upper and lower spacers 30 and 31, respectively. The upper spacer 30 is seated on a shoulder 32 on the core body 27. The outer gear 29 has a larger interior diameter than the lower spacer 31. Inclined teeth 34 extend around the interior of the outer gear 29 for meshing with similarly shaped and inclined teeth 35 on an inner, disc-shaped gear 36, which is, in effect, a sun gear.

The inner gear 36 is rotatably mounted on a pin 38 on the flat base 39 of a semicircular recess 40 in one side of the core body 27. Rotation of the inner gear 36 results in a corresponding rotation of the outer gear 29 around the longitudinal axis of the core body 27. The recess 40 intersects an inclined passage 42 through the center of the core body 27. The inner gear 36 is rotated by a worm shaft 43 which is rotatably mounted in the passage 42. Helical threads 44 on the shaft 43 mesh with the inner gear 36. The cylindrical bottom end 46 of the shaft 43 is rotatable in an inclined recess 47 in the bottom wall 10 of the housing 1. The shaft 43 is held in the housing 1 by a cylindrical lock screw 49, which bears against a shoulder 50 on the shaft 43. External threads on the screw 49 engage the threaded upper end of a passage 51 through an inclined projection 53 on the center of the housing top wall 9.

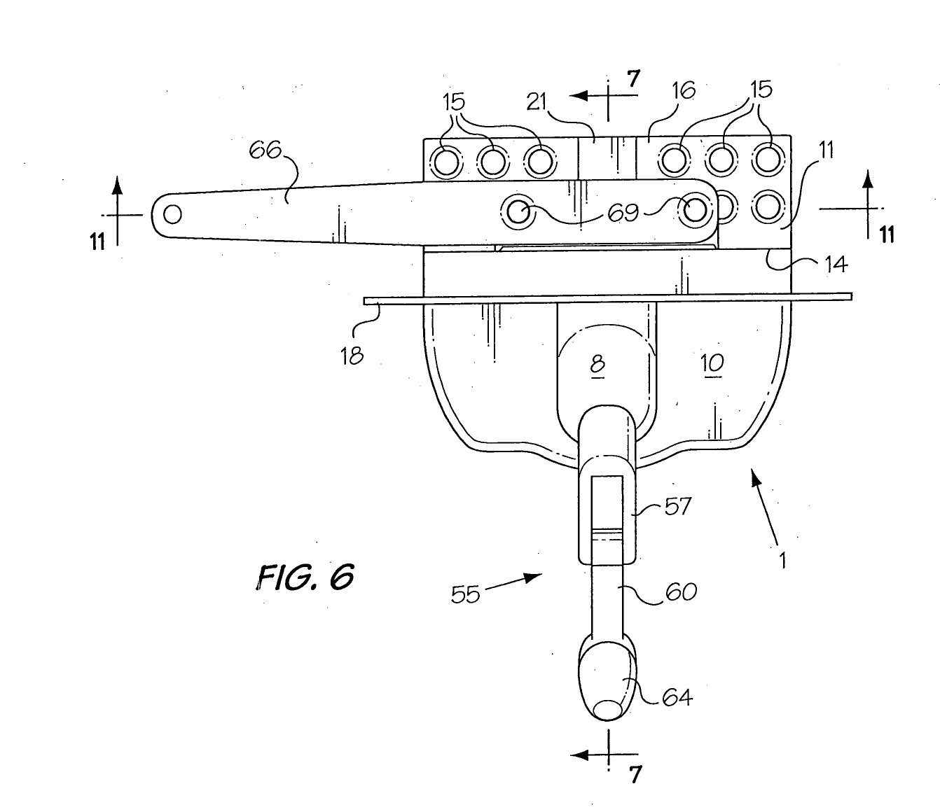

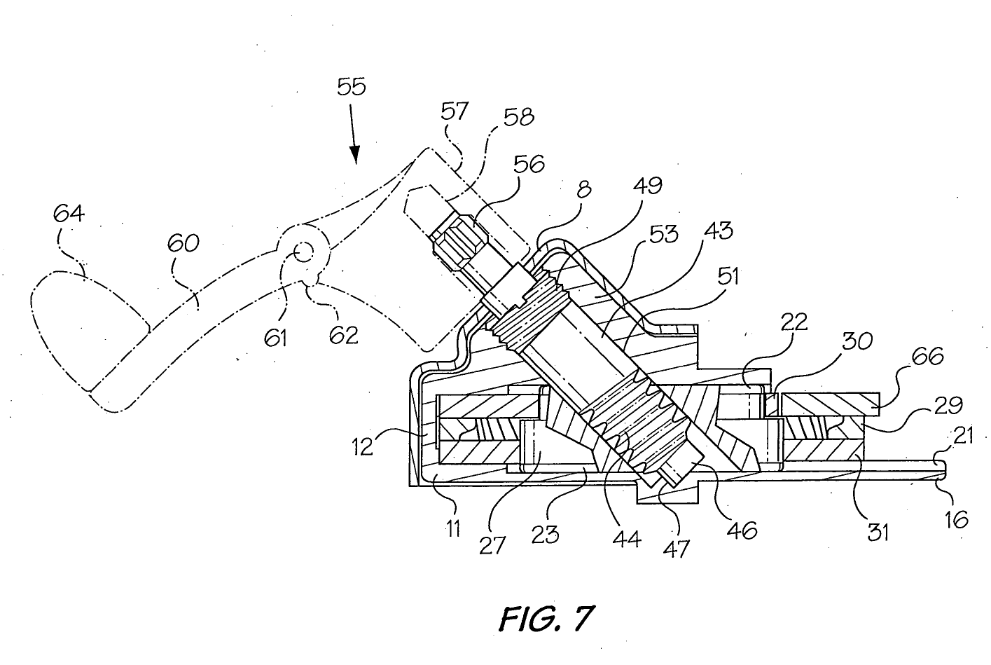

A handle assembly, which is indicated generally at 55, is mounted on the splined upper end 56 of the shaft 43. The assembly 55 includes a base 57 with a splined socked 58 for mounting on the shaft 43, and a handle 60 pivotally connected to the base 57 by a pin 61. A convex, transversely extending rib 62 on the cylindrical, body end of the handle 60 limits rotation of the handle when the latter is rotated from a non-use, storage position (not shown) on the base 57 to the use position (FIGS. 1, 6 and 7). A knob 64 secured to the outer, free end 65 of the handle 60 by a screw 66 facilitates manual manipulation of the handle.

Immediately prior to mounting the handle assembly 55 on the housing 1, the thin, plastic rover 2 is mounted on the housing. An arm 66, which forms part of a conventional lever system (not shown) for opening and closing a window, is mounted on a rectangular projection 67 on the outer gear 29. The projection 67 extends outwardly from the open end 14 of the housing 1. Spaced apart snap pins 69 on the projection 67 mate with holes in the arm 66.

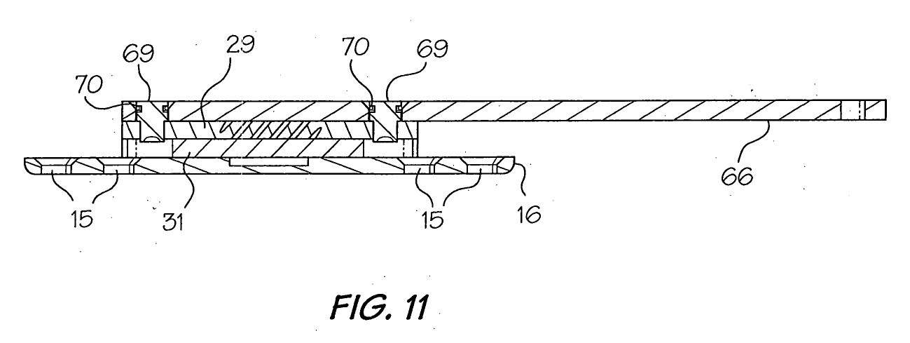

Snap rings 70 placed in annular grooves 72 (FIG. 11) near the outer free ends of the pins 69 hold the arm 66 on the outer gear 29. Obviously, it is a simple matter to reverse the arm 66 on the pins 69. The arm is lifted off the pins 69 causing the snap rings 71 to compress and then expand, the arm is rotated 180°, and the arm 66 is again placed on the pins 69. When the arm 66 is reinstalled, the rings 71 compress and again expand to hold the arm on the pins 69. This process applies to a retrofit situation. Normally, the operating mechanism is installed in a window frame when a window is being produced. Depending upon the intended opening direction, i.e. which side of the window sash carries the hinges, the arm 66 is installed to point in the appropriate direction.

Thus, it will be appreciated that the above described mechanism is much simpler in terms of structure than other assemblies intended for the same purpose. Moreover, the mechanism of the present invention makes it substantially easier to change the direction of window opening.

I claim:

1. An operating mechanism for a casement window comprising:
(a) a hollow, closed housing for mounting on a casement window frame, said housing including:
(i) an opening in one side thereof;
(b) a worm shaft rotatable in said housing for manual actuation of the mechanism;
(c) an inner gear in said housing for rotation by said worm shaft;
(d) an annular outer gear in said housing for rotation by said inner gear, said outer gear including
(i) a flange extending out of said opening in the housing;
(e) spaced apart pins on said flange; and
(f) a crank arm releasably mounted on said pins for extending in one of two opposed directions,
whereby the operating mechanism can be readily adapted to windows opening in opposite directions.

2. The window operating mechanism of claim 1 including a core body fixed in said housing and rotably supporting said inner gear and said annular gear, said worn shaft being rotatable in said core body in engagement with said inner gear.

3. The window operating mechanism of claim 2, including upper and lower rectangular projections on said core body, and upper and lower notches in said housing for slidably receiving said projections to facilitate fixed mounting of said core body in the housing.

4. The window operating mechanism of claim 3, including upper and lower annular spacers on said core body rotatably supporting said outer gear on the core body in the housing.

5. The window operating mechanism of claim 3, including annular grooves in said pins on the flange of the outer gear, and snap rings in said annular grooves for releasably retaining the crank arm on the outer gear.

6. A window operating mechanism comprising:
(a) a hollow casing defined by:
(i) a top wall;
(ii) a bottom wall;
(iii) an outer end wall and side walls extending between the peripheral edges of said top and bottom walls; and
(iv) an open inner end, said bottom wall extending outwardly from the bottom wall beyond said open inner end for securing the casing to a window frame;
(b) an annular outer gear rotatably in said housing including:
(i) a flange extending through said open inner end of the casing; and
(ii) spaced apart pins on said flange
(c) a crank arm releasably mounted on said flange for rotation with said outer gear to open or close a window including:
(i) holes spaced apart in said crank arm the same distance as said pins on said flange, whereby the crank arm can be reversed on said flange for operating windows opening in opposite directions;
(d) an inner gear rotatable in said housing meshing with said outer gear for rotating the outer gear;
(e) a worm shaft rotatable in said casing and meshing with said inner gear for rotating the inner gear and consequently said outer gear; and
(f) a handle on an outer end of said shaft for rotating the shaft, whereby the outer gear and consequently the crank arm are caused to rotate to open or close a window.
